(19) United States
(12) Patent Application Publication
(10) Pub. No.: US 2005/0240463 A1
(43) Pub. Date: Oct. 27, 2005

(54) Method of estimating the impact on potential customers of a revision in a semiconductor technology process

(75) Inventors: Yu Jen Chen, Taipei (TW); Chen-Han Lien, Tainan (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/829,490

(22) Filed: Apr. 22, 2004

(51) Int. Cl. G06F 17/60

(52) U.S. Cl. 705/10; 705/8

(57) ABSTRACT

A customer impact estimation system to evaluate the impact to a customer by a revision of a technology process in microelectronics manufacturing includes a user interface configured to accept a predefined search scope and a predefined search scheme; an extraction module configured to search and extract information of a customer who has used a design technical documents database, wherein the design technical documents database include information related to the technology process; and an estimation module configured to analyze the information of the customer and evaluate that information for the impact to the customer by the revision of the technology process.

### BACKGROUND

The present disclosure relates generally to a semiconductor fabrication system and, more particularly, to a computer-based system and method for estimating potential customer impact within the semiconductor fabrication system.

In a semiconductor manufacturer such as a semiconductor foundry, several varieties of products are manufactured. The products may include different types such as analog, logic, mixed signal, radio frequency (RF), memory, image sensor, and microelectronic mechanical system (MEMS). The products may involve different technology nodes including 0.25 μm, 0.18 μm, 0.15 μm, 0.13 μm, 0.11 μm, 90 nm, and 65 nm. The products may involve different designs including complementary metal-oxide-semiconductor field effect transistor (CMOSFET), strained CMOSFET, fin-structure FET (FINFET), silicon on insulator (SOI), high voltage transistor. The products may be implemented by different processing including dual damascene processing, salicide processing, immersion lithography, chemical mechanical polishing (CMP), and atomic layer deposition (ALD). The products may involve different materials including low k material, high k material, silicon substrate, silicon germanium substrate, silicon carbide substrate, and metal silicide. Furthermore, the products may be ordered from different customers. If the semiconductor manufacturer makes a change in a manufacturing process, the corresponding impact to customers may be more or less, depending on how many customers are impacted and how seriously they are impacted. It is difficult to extract information and evaluate impact resulting from such a change. It is also hard to know if the change is cost effective and beneficial in the long term.

Accordingly, what is needed in the art is a system and method thereof that addresses the above discussed issues.

### BRIEF DESCRIPTION OF THE DRAWINGS

FIG. 1 illustrates a schematic view of one embodiment of a system constructed according to aspects of the present disclosure.

FIG. 2 illustrates a schematic view of one embodiment of an example virtual integrated circuit fabrication system constructed according to aspects of the present disclosure.

FIG. 3 illustrates a schematic view of another embodiment of an example virtual integrated fabrication system constructed according to aspects of the present disclosure.

FIG. 4 illustrates a schematic view of another embodiment of an alternate virtual integrated circuit fabrication system constructed according to aspects of the present disclosure.

FIG. 5 illustrates a schematic view of one embodiment of a customer impact estimation system constructed according to aspects of the present disclosure.

FIG. 6 illustrates a flow chart of one embodiment of a method to estimate potential customer impact constructed according to aspects of the present disclosure.

FIG. 7 illustrates a schematic view of an embodiment of an integrated circuit device constructed according to aspects of the present disclosure.

### DETAILED DESCRIPTION

A method and system is provided for estimating potential customer impact by the revision of a specific technology process. It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

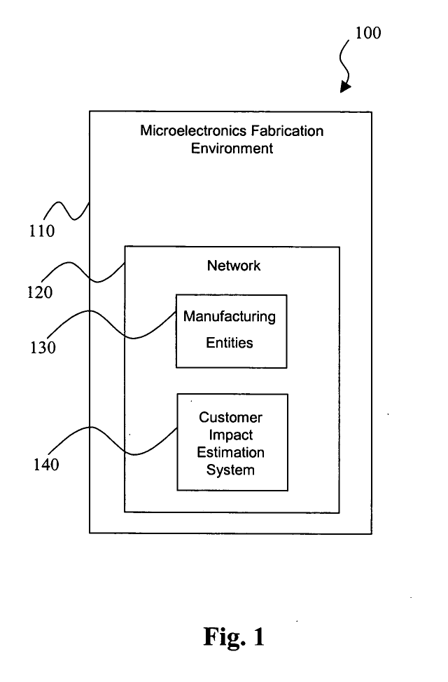

FIG. 1 illustrates a schematic view of one embodiment of a system 100 constructed according to aspects of the present disclosure. The system 100 includes a microelectronics fabrication environment 110, a network 120, a plurality of manufacturing entities 130, and a customer impact estimation system 140.

The microelectronics fabrication environment 110 includes a microelectronics foundry business. The foundry business may include multiple manufacturing facilities for the fabrication of variety of different microelectronics products. For example, there may be at least one manufacturing facility for the front end fabrication of a plurality of microelectronics products, while a second manufacturing facility may provide the back end fabrication for the packaging of the microelectronics products, and a third manufacturing facility may provide other services for the foundry business. The foundry business may further include an unlimited number of fabrication facilities interconnected through the network 120.

The network 120 includes a plurality of interconnecting nodes (not shown) for the communication of manufacturing information. The information may include a plurality of databases for the manufacturing entities 130. The network 120 may include wired and/or wireless interconnection. The network 120 may further provide interconnectivity between manufacturing facilities of the microelectronics fabrication environment 110.

The plurality of manufacturing entities 130 includes a plurality of manufacturing process tools, metrology tools, customer interfaces, a manufacturing executing system, and other entities associated with the microelectronics fabrication environment 110.

The customer impact estimation system 140, in one embodiment, includes a plurality of modules for the function of searching, extracting, analyzing, and estimating of manufacturing related documents and customers. The customer impact estimation system 140 provides a method to evaluate or identify potential customers to be impacted, and to also determine potential impacts to identified customers, vendors, and makers. The customer impact estimation system 140 provides a plurality of computer-implemented systems and methods for estimating potential customer impact due to a revision of a specific technology process. The customer impact estimation system 140 may interact with the plurality of manufacturing entities 130, and execute functions through the network 120.

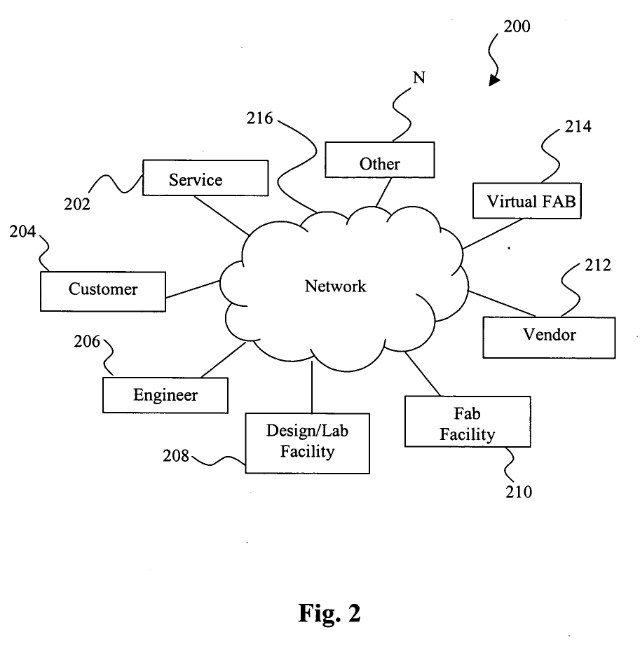

Referring to FIG. 2, in another embodiment, a virtual IC fabrication system (a “virtual fab”) 200, within which the system 100 of FIG. 1, may be performed, is illustrated. The virtual fab includes a plurality of entities 202, 204, 206, 208, 210, 212, 214, . . . , N that may be connected by a communications network 216. The network 216 may be a single network or may be a variety of different networks, such as an intranet and the Internet, and may include both wireline and wireless communication channels.

In the present example, the entity 202 represents a service system for service collaboration and provision, the entity 204 represents a customer, the entity 206 represents an engineer, the entity 208 represents a design/laboratory (lab) facility for IC design and testing, the entity 210 represents a fabrication (fab) facility, and the entity 212 represents a vendor, and the entity 214 represents another virtual fab (e.g., a virtual fab belonging to a subsidiary or a business partner). Each entity may interact with other entities and may provide services to and/or receive services from the other entities.

For purposes of illustration, each entity 202-212 may be referred to as an internal entity (e.g., an engineer, customer service personnel, an automated system process, a design or fabrication facility, etc.) that forms a portion of the virtual fab 200 or may be referred to as an external entity (e.g., a customer) that interacts with the virtual fab 200. It is understood that the entities 202-212 may be concentrated at a single location or may be distributed, and that some entities may be incorporated into other entities. In addition, each entity 202-212 may be associated with system identification information that allows access to information within the system to be controlled based upon authority levels associated with each entity's identification information.

The virtual fab 200 enables interaction among the entities 202-212 for the purpose of IC manufacturing, as well as the provision of services. In the present example, IC manufacturing includes receiving a customer's IC order and the associated operations needed to produce the ordered ICs and send them to the customer, such as the design, fabrication, testing, and shipping of the ICs.

One of the services provided by the virtual fab 200 may enable collaboration and information access in such areas as design, engineering, and logistics. For example, in the design area, the customer 204 may be given access to information and tools related to the design of their product via the service system 202. The tools may enable the customer 204 to perform yield enhancement analysis, view layout information, and obtain similar information. In the engineering area, the engineer 206 may collaborate with other engineers using fabrication information regarding pilot yield runs, risk analysis, quality, and reliability. The logistics area may provide the customer 204 with fabrication status, testing results, order handling, and shipping dates. It is understood that these areas are exemplary, and that more or less information may be made available via the virtual fab 200 as desired.

Another service provided by the virtual fab 200 may integrate systems between facilities, such as between the design/lab facility 208 and the fab facility 210. Such integration enables facilities to coordinate their activities. For example, integrating the design/lab facility 208 and the fab facility 210 may enable design information to be incorporated more efficiently into the fabrication process, and may enable data from the fabrication process to be returned to the design/lab facility 210 for evaluation and incorporation into later versions of an IC. The vendor 212 may include an electronic design automation (EDA) vendor, a chip service company, and library/library/intellectual property(IP) vendor. The EDA vendor may provide semiconductor design tools for design engineers. The chip service company may provide service including IC designing. The library/IP vendor may provide standard IC cell for IC designing.

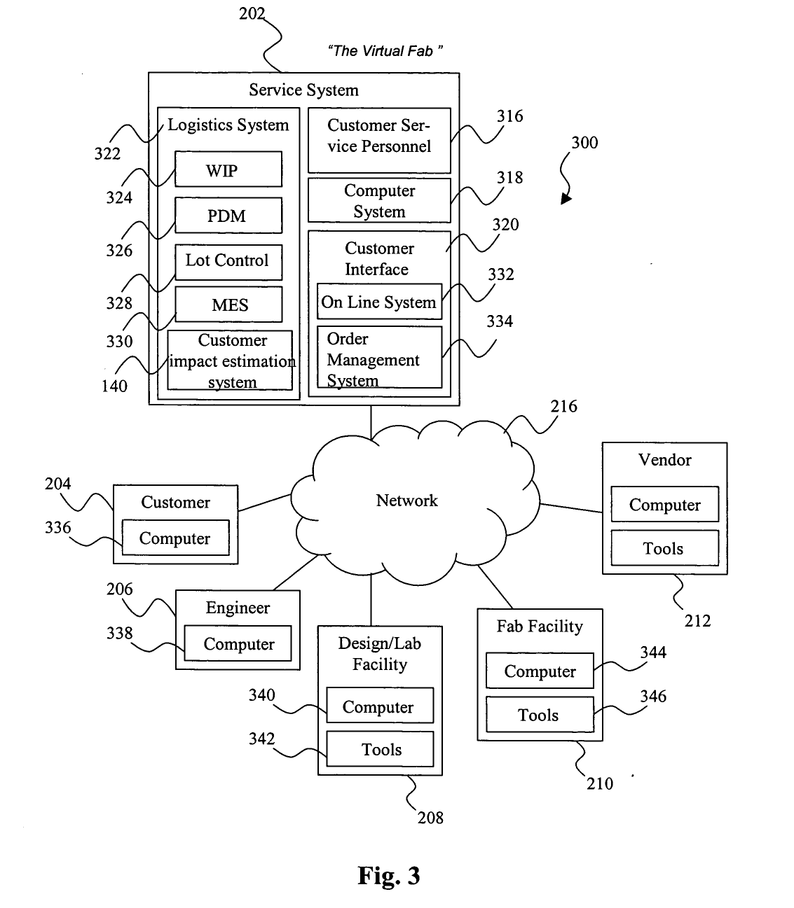

Referring to FIG. 3, in another embodiment, a virtual fab 300 illustrates one possible implementation of the virtual fab 200 of FIG. 2. The virtual fab 300 includes a plurality of entities 202, 204, 206, 208, 210, and 212 that are connected by a communications network 216. In the present example, the entity 202 represents a service system, the entity 204 represents a customer, the entity 206 represents an engineer, the entity 208 represents a design/lab facility for IC design and testing, the entity 210 represents a fab facility, and the entity 212 represents a process (e.g., an automated fabrication process). Each entity may interact with other entities and may provide services to and/or receive services from the other entities.

The service system 202 provides an interface between the customer and the IC manufacturing operations. For example, the service system 202 may include customer service personnel 316, a computer system 318, a customer interface 320 for enabling a customer to directly access various aspects of an order, and a logistics system 322 for order handling and tracking.

The logistics system 322 may include a work-in-process (WIP) inventory system 324, a product data management system 326, a lot control system 328, and a manufacturing execution system (MES) 330, and a customer impact estimation system 140. The WIP inventory system 324 may track working lots using a database (not shown). The product data management (PDM) system 326 may manage product data and maintain a product database (not shown). The product database could include product categories (e.g., part, part numbers, and associated information), as well as a set of process stages that are associated with each category of products. The lot control system 328 may convert a process stage to its corresponding process steps.

The MES 330 may be an integrated computer system representing the methods and tools used to accomplish production. In the present example, the primary functions of the MES 330 may include collecting data in real time, organizing and storing the data in a centralized database, work order management, workstation management, process management, inventory tracking, and document control. The MES 330 may be connected to other systems both within the service system 202 and outside of the service system 202. Examples of the MES 330 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 330 may include such information as a process step sequence for each product.

The customer impact estimation system 140 may be integrated into the service system 202 or/and may function in the design/lab facility entity 208. The customer impact estimation system 140 may provide search, collection, extraction, filtering, and estimation of documents and customers associated with a myriad of operations including the virtual fab 200.

The customer interface 320 may include an online system 332 and an order management system 334. The online system 332 may function as an interface to communicate with the customer 204, other systems within the service system 202, supporting databases (not shown), and other entities 206-212. The order management system 334 may manage client orders and may be associated with a supporting database (not shown) to maintain client information and associated order information.

Portions of the service system 302, such as the customer interface 320, may be associated with a computer system 318 or may have their own computer systems. In some embodiments, the computer system 322 may include multiple computers, some of which may operate as servers to provide services to the customer 204 or other entities. The service system 202 may also provide such services as identification validation and access control, both to prevent unauthorized users from accessing data and to ensure that an authorized customer may access only their own data.

The customer 204 may obtain information about the manufacturing of its ICs via the virtual fab 200 using a computer system 336. In the present example, the customer 204 may access the various entities 202, 206-212 of the virtual fab 200 through the customer interface 320 provided by the service system 202. However, in some situations, it may be desirable to enable the customer 204 to access other entities without going through the customer interface 320. For example, the customer 204 may directly access the fab facility 210 to obtain fabrication related data.

The engineer 206 may collaborate in the IC manufacturing process with other entities of the virtual fab 300 using a computer system 338. The virtual fab 300 enables the engineer 206 to collaborate with other engineers and the design/lab facility 208 in IC design and testing, to monitor fabrication processes at the fab facility 210, and to obtain information regarding test runs, yields, etc. In some embodiments, the engineer 206 may communicate directly with the customer 204 via the virtual fab 300 to address design issues and other concerns.

The design/lab facility 208 provides IC design and testing services that may be accessed by other entities via the virtual fab 200. The design/lab facility 208 may include a computer system 340 and various IC design and testing tools 342. The IC design and testing tools 342 may include both software and hardware.

The fab facility 210 enables the fabrication of ICs. Control of various aspects of the fabrication process, as well as data collected during the fabrication process, may be accessed via the virtual fab 300. The fab facility 210 may include a computer system 344 and various fabrication hardware and software tools and manufacturing equipment 346. For example, the fab facility 210 may include an ion implantation tool, a chemical vapor deposition tool, a thermal oxidation tool, a sputtering tool, and various optical imaging systems, metrology tool, as well as the software needed to control these components.

The process 212 may represent any process or operation that occurs within the virtual fab 300. For example, the process 212 may be an order process that receives an IC order from the customer 204 via the service system 202, a fabrication process that runs within the fab facility 210, a design process executed by the engineer 206 using the design/lab facility 208, or a communications protocol that facilities communications between the various entities 202-212. The process 212 may include a computer system 344 and various fabrication hardware and software tools and manufacturing equipment 346.

It is understood that the entities 202-212 of the virtual fab 300, as well as their described interconnections, are for purposes of illustration only. For example, it is envisioned that more or fewer entities, both internal and external, may exist within the virtual fab 200, and that some entities may be incorporated into other entities or distributed. For example, the service system 202 may be distributed among the various entities 206-210.

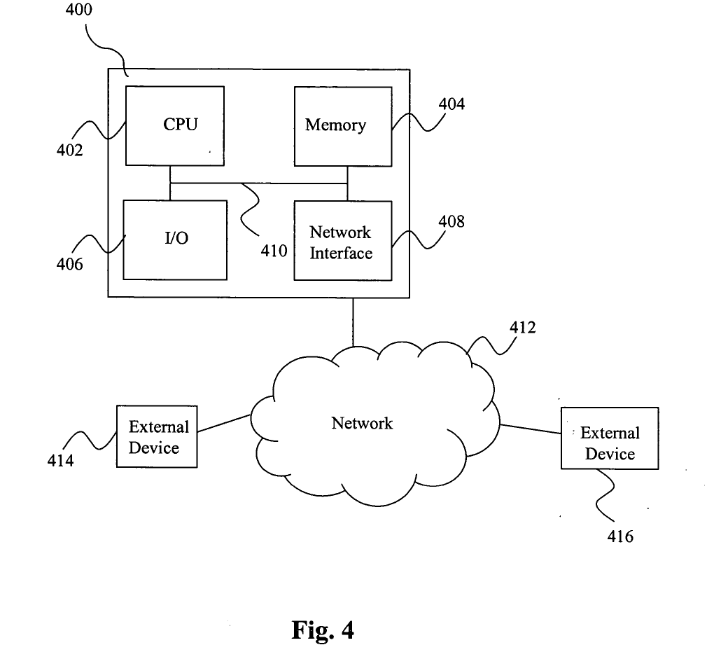

Referring to FIG. 4, an exemplary computer 400, such as may be used within the virtual fab 200 of FIG. 2 or virtual fab 300 of FIG. 3, is illustrated. The computer 400 may include a central processing unit (CPU) 402, a memory unit 404, an input/output (I/O) device 406, and a network interface 408. The network interface may be, for example, one or more network interface cards (NICs). The components 402, 404, 406, and 408 are interconnected by a bus system 410. It is understood that the computer may be differently configured and that each of the listed components may actually represent several different components. For example, the CPU 402 may actually represent a multi-processor or a distributed processing system; the memory unit 404 may include different levels of cache memory, main memory, hard disks, and remote storage locations; and the I/O device 406 may include monitors, keyboards, and the like.

The computer 400 may be connected to a network 412, which may be connected to the networks 216 (FIGS. 2 and 3). The network 412 may be, for example, a complete network or a subnet of a local area network, a company wide intranet, and/or the Internet. The computer 400 may be identified on the network 412 by an address or a combination of addresses, such as a media control access (MAC) address associated with the network interface 408 and an internet protocol (IP) address. Because the computer 400 may be connected to the network 412, certain components may, at times, be shared with other devices 414 and 416. Therefore, a wide range of flexibility is anticipated in the configuration of the computer. Furthermore, it is understood that, in some implementations, the computer 400 may act as a server to other devices 414 and 416. The devices 414 and 416 may be computers, personal data assistants, wired or cellular telephones, or any other device able to communicate with the computer 400.

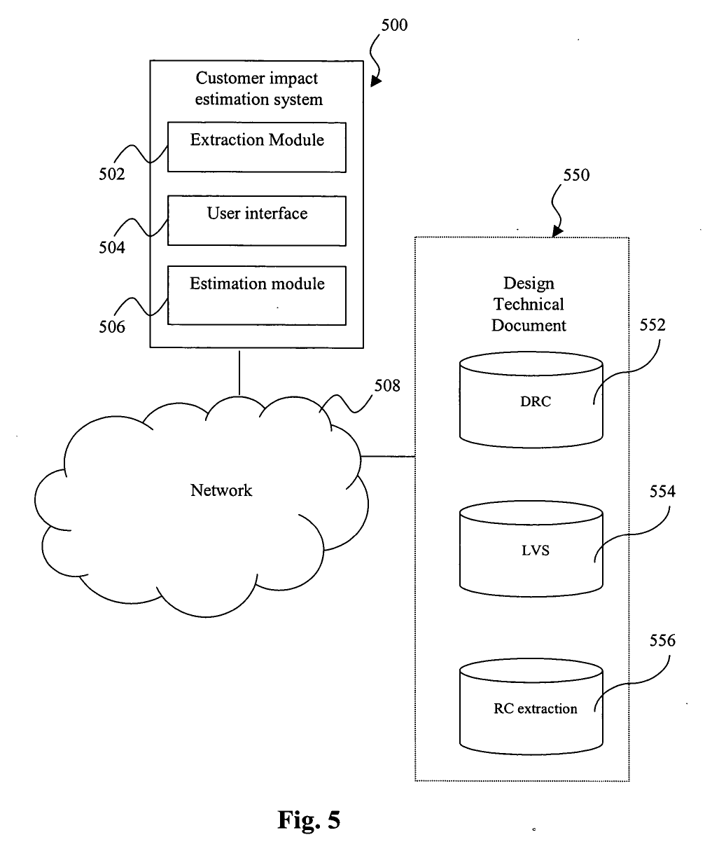

Referring to FIG. 5, illustrated is a schematic view of one embodiment of a customer impact estimation system 500 constructed according to aspects of the present disclosure. Customer impact estimation system 500 of FIG. 5 may be employed as customer impact estimation system 140 discussed above with reference to FIG. 1. The customer impact estimation system 500 includes an extraction module 502, a user interface 504, and an estimation module 506.

The extraction module 502 receives search order and other information including a specific technology revision from the user interface. The extraction module 502 will implement searching through the network 508. The searching, by the extraction module 502, may cover the design technical document 550 and other related databases in the virtual fab 200 of FIG. 2 or the virtual fab 300 of FIG. 3. The searching may take a top down approach such as defining technology revision, searching relevant documents and then searching relevant customers who have downloaded the relevant documents during the predefined search scope. Searched information by the extraction module 502 may include documents impacted by a revision of a specific technology process, potential customers to be impacted, and technology information of the potential customers to be impacted including downloading history of the customers.

A change or revision of technology process (technology change) may be a change of semiconductor technology associated with semiconductor processing including design rules, design tool, design library cells, and design tool, may further include design vendor including EDA vendor, chip service vendor, and library/IP vendor; processing tools; semiconductor material (conductive material and dielectric material for example); processing method; processing recipe; wafer patterning feature size; and manufacturer.

The relevant document may include process documents and technical files. The process documents further include design rule manual, Spice model document, and etc. to provide process attributes for design engineers. The technical files further include design rule check (DRC) files, layout versus schematic (LVS) files, RC extraction files, and other files for design tool.

The user interface 504 can take input from users about technology to be revised, search scope, or/and search scheme. For example, a technology revision is about design rule change on 0.13 μm technology node. In that case the searching may be searching for documents wherein the document title may contain both “design rule” and “0.13 μm” if the search key is defined as document title.

The estimation module 506 could function to evaluate potential customers to be impacted, potential impacts to the customers, the relationship of a customer to a specific technology, the technology trend of a customer, and the overall impact by the revision of a specific technology process, all based on searched information by the extraction module 502. The evaluation can be expressed as a list of customers to be impacted by a revision of a specific technology, or a quantitative parameter to represent the overall impact by the revision, or a trend of the customer in semiconductor technology. The evaluation information may be used for a decision with respect to a technology change, or other management decisions associated with customers.

The customer impact estimation system 500 is connected to a network 508. The network 508 may include the virtual fab 200 of FIG. 2 or virtual fab 300 of FIG. 3.

The customer impact estimation system 500 may further include a design technical document 550. Alternatively, the design technical document 550 can be connected to the network 508 and is accessible to the customer impact estimation system 500 through the network 508. The design technical document 550 provides information of manufacturing and design for semiconductor products. The design technical document 550 further includes a design rule check (DRC) database 552, a layout versus schematic (LVS) database 554, and an RC extraction database 556. The design technical document 550 may further include other technical files associated with semiconductor design, processing, and fabrication.

The design rule check database 552 includes a plurality of rules to be used to check if there is any violation in a new layout design. Although designers might be conscious of the design rules when performing the layout, there is a possibility of overlooking and thus violating the design rules. So, the DRC is a step taken to prompt users with respect to any violations since the violation of any design rules would result in a higher probability, and in some cases an absolute certainty, that the fabricated chip does not work as desired. A technology change may impact DRC database 552.

For example, the propensity for damage to the circuitry on a wafer can be exacerbated by the existence of ‘antenna’ structures. An ‘antenna’ is an interconnect, i.e., a conductor like polysilicon or metal, that is not electrically connected to silicon, i.e., not ‘grounded’, during the processing steps of the wafer. The connection to silicon would normally provide an electrical path to bleed-off any accumulated charges. If the connection to silicon does not exist, charges may build up on the interconnect to the point at which rapid discharge does take place and permanent physical damage results, e.g., to MOSFET gate oxides. This destructive phenomenon is known as the ‘antenna effect’. The ‘antenna ratio’ of an interconnect is used to predict if the antenna effect will occur. ‘Antenna ratio’ is defined as the ratio between the physical area of the conductors making up the antenna to the total gate oxide area to which the antenna is electrically connected. A higher ratio implies a greater propensity to failure due to the antenna effect. This can result either from a relatively larger area to collect charge or a reduced gate oxide area on which the charge is concentrated. For example, a ratio of 100:1 is a typical design rule upper limit. This rule can be incorporated into the DRC database. Any new layout design could be tested and checked using the DRC database for any violation. If the metal, the dielectric material, and the feature size are changed, then the antenna ratio in the DRC database may also be changed accordingly.

The LVS database 554 may include a plurality of technical files for converting a layout design to a schematic design, further match the converted schematic design to the original schematic design in circuit function, and verify the layout design. The conversion step needs to extract information of electronic connections among components from the layout files (photomask information). The matching step includes replacing a circuit cell with an equivalent cell which has the same function. If technology has a change, such as a new circuit cell for a certain function, then LVS technical files in the LVS database may need to be updated accordingly.

The RC extraction database 556 may include technical files for extracting parasitic resistance and capacitance (RC) in circuit, calculating time delay from the layout design files, and analyzing timing. RC are not only related to the layout, but also relates to materials such as inter-level dielectric (ILD) and the metal for interconnection. If materials used in ILD are changed, such changes may need to be incorporate into the RC extraction database 556.

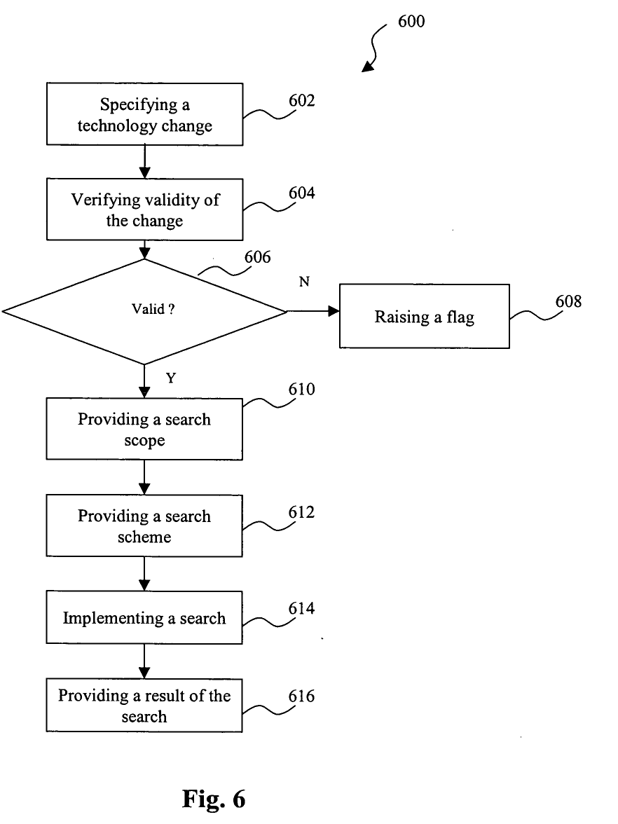

FIG. 6 is a flow chart of one embodiment of a method 600 for estimating the potential customer impact formed according to aspects of the present disclosure.

The method 600 begins at step 602 by specifying a technology change. The technology change may be a change of semiconductor technology associated with semiconductor processing including design rules, design tool, design library cells, and design tool, may further include design vendor including EDA vendor, chip service vendor, and library/IP vendor; processing tools; semiconductor material (conductive material and dielectric material for example); processing method; processing recipe; wafer patterning feature size; and manufacturer. All above mentioned changes and other changes may cause relevant technical documents to be revised accordingly, and impact certain customers. Estimation of the impact of the change to customers is efficiently performed by the disclosed method. The technology change can be specified and defined by a user through the user interface 504 of the customer impact estimation system 500. The technology change may be categorized in terms of a document or documents impacted by the change. For example, if a change is a design rule change, then all documents associated with that design rule may be searched. In another embodiment, if a change is related to a library/IP vendor, then all files related to the library/IP vendor may be searched and traced for impacted customers.

In step 604, extraction module 502 verifies if such change is valid, or acceptable by a plurality of predefined criteria. For example, if a technology change is changing the process from 0.13 μm to 5 nm, then this change may be rejected by the system since 5 nm process may not be available. In step 606, if the change is valid, the method 600 will proceed to the next step 610. Otherwise, the method will raise a flag to the user at step 608.

In step 610, a scope of search may be given by the user or a set of default values from the customer impact estimation system 500, or automatically produced by the system 500. The scope of search may include a period of time, a type of technology, and a physical region of a customer. For example, the period of time may define search time span during which a related document has been downloaded and used by at least one customer.

In step 612, a search scheme is defined by the user, the extraction system 502, or is extracted from the predefined search scheme according to the technology change. The search scheme may include document title, document number, vendor, maker, and end customer. The maker may include internal manufacturers and partners who provide manufacturing service. Vendor may include electronic design automation (EDA) vendor, chip service vendor, and library/IP vendor. The EDA vendor may provide semiconductor design tools for design engineers. The chip service company may provide service including IC designing. The library/IP vendor may provide standard IC cell for IC designing. The search scheme may define a way to implement search. For example, if search scheme is by document title, then the method 600 may search and provide titles of all documents to be impacted by the technology change. In another example, if search scheme is by vendor, then the method 600 may search and provide a list of all impacted vendors. In another embodiment, if search scheme is by a combination of maker, vendor, and end customer, then the method 600 may search and provide a list of all impacted vendors, makers, and end customers.

In step 614, a search is implemented by the extraction module 502. The search is defined according to the scope of search and the scheme of search. The search may include multiple steps. For example, the method 600 may first search for documents to be impacted according to the scope and the scheme, then search for customers to be impacted according to the documents to be impacted and download history of each document. The search may further include searching a download history of a customer for more analysis of the customer.

In step 616, the method 600 may provide a result of the search through the user interface 504. The result may be a list of potential makers, vendors, and end customers to be impacted. The result may be a list of potential customers to be impacted, each with an impact value to present for impact range. The result may be a quantitative parameter to present for an overall impact.

The method may further include an evaluation step implemented by the estimation module 506. Further information of each customer in downloading documents may be extracted in this step or step 614, and analysis of the further information can be carried out. Such analysis may provide an evaluation of the customer for its technology trend or future impact. Such evaluation can be used for business management, customer service, and vendor/maker coordination.

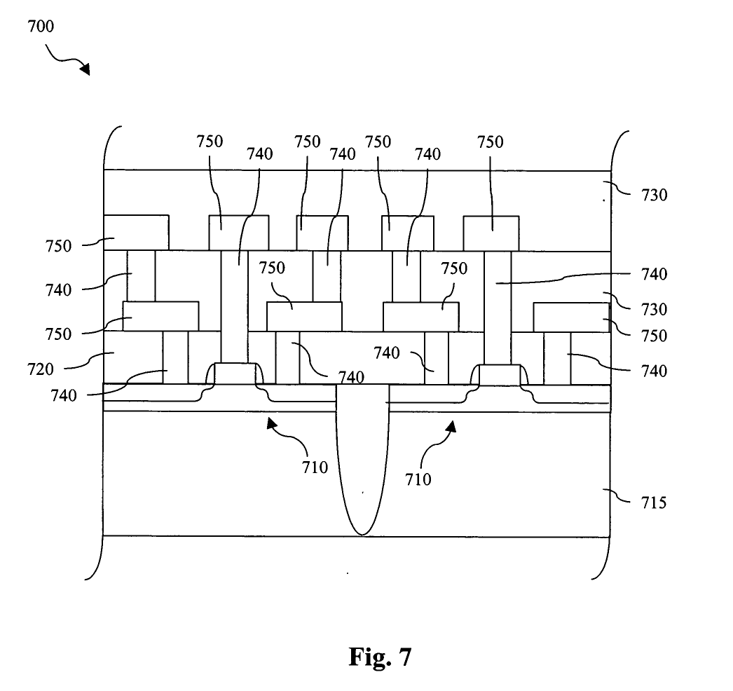

FIG. 7 is a sectional view of one embodiment of an integrated circuit device 700 constructed according to aspects of the present disclosure. The integrated circuit device 700 is one example type of manufactured semiconductor device to which the customer impact estimation system 140 may be applied. For example, the integrated circuit device 700 may be a semiconductor product or a portion of a semiconductor product ordered by a plurality of customers. The integrated circuit device 700 may be one example of a semiconductor device that engineer 206 and fab facility 210, illustrated in FIG. 2 and FIG. 3, manufacture or are planning to manufacture. The integrated circuit device 700 may also be one example of a semiconductor device which design/lab facility 208 and vendor 212 including EDA vendor, chip service company, and library/IP vendor, illustrated in FIG. 2 and FIG. 3, provide design tools and design services.

The integrated circuit device 700 may include a plurality of microelectronics devices 710. The microelectronics devices 710 may be formed from, in or on a common substrate 715 which may be substantially similar in composition and manufacture to the substrate 715. Of course, the integrated circuit device 700 may include other types of substrates, or multiple substrates, within the scope of the present disclosure.

The substrate 715 may include a plurality of microelectronics devices 710, wherein one or more layers of such a gate structure, or other features contemplated by the integrated circuit device 700 within the scope of the present disclosure, may be formed by chemical-vapor deposition (CVD), physical-vapor deposition (PVD), plasma-enhanced CVD (PECVD), atomic layer deposition (ALD) and/or other process techniques. Conventional and/or future-developed etching and other processes may be employed to define the integrated circuit device 500 from the deposited layer(s).

Of course, the present disclosure is not limited to applications in which the integrated circuit device 700 is a gate structure or the microelectronic device 710 is a transistor or other semiconductor device. For example, in one embodiment, the microelectronic device 710 may be or include an electrically programmable read only memory (EPROM) cell, an electrically erasable programmable read only memory (EEPROM) cell, a static random access memory (SRAM) cell, a dynamic random access memory (DRAM) cell and/or other microelectronic devices (hereafter collectively referred to as microelectronic devices). The geometric features of the microelectronics device 710 may range between about 1300 Angstroms and about 3 Angstroms.

The substrate 715 may be a silicon-on-insulator (SOI) substrate, and may include silicon, gallium arsenide, strained silicon, silicon germanium, carbide, diamond and/or other materials. The substrate 715 may also include one or more uniformly or complementary doped wells. While not limited to any particular dopant types or schemes, in one embodiment, the doped wells employ boron as a p-type dopant and deuterium-boron complexes for an n-type dopant. The deuterium-boron complexes may be formed by plasma treatment of boron-doped diamond layers with a deuterium plasma.

The doped wells may also include n-type deuterium-boron complex regions of the substrate 715, which may be formed by treating the above-described boron-doped regions employing a deuterium plasma. For example, selected areas of the substrate 715 may be covered by photoresist or another type of mask such that exposed boron-doped regions may be treated with the deuterium containing plasma. The deuterium ions may provide termination of dangling bonds, thereby transmuting the p-type boron-doped regions into n-type deuterium-boron complex regions. Alternatively, deuterium may be replaced with tritium, hydrogen and/or other hydrogen containing gases. The concentration of the n-type regions may generally be controlled by a direct current (DC) or a radio frequency (RF) bias of the substrate 715. The above-described processes may also be employed to form lightly-doped source/drain regions in the substrate 715. Of course, other conventional and/or future-developed processes may also or alternatively be employed to form the source/drain regions.

The integrated circuit device 700 also includes one or more insulating layers 720, 730 located over the microelectronics devices 710. The first insulating layer 720, which may itself include multiple insulating layers, may be planarized to provide a substantially planar surface over the plurality of microelectronics devices 710.

The integrated circuit device 700 also includes vertical interconnects 740, such as conventional vias or contacts, and horizontal interconnects 750 (all spatial references herein are for the purpose of example only and are not meant to limit the disclosure). The interconnects 740 may extend through one or more of the insulating layers 720, 730, and the interconnects 750 may extend along one of the insulating layers 720, 730 or a trench formed therein. In one embodiment, one or more of the interconnects 740, 750 may have a dual-damascene structure. The interconnects 740, 750 may be formed by etching or otherwise patterning the insulating layers 720, 730 and subsequently filling the pattern with refractive and/or conductive material, such as tantalum nitride, copper and aluminum.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

1. A customer impact estimation system to evaluate impact to a customer by a revision of a technology process in microelectronics manufacturing, the system comprising:
a user interface configured to accept a predefined search scope and a predefined search scheme;
an extraction module, responsive to the user interface, configured to search and extract information of a customer who has used a design technical documents database, wherein the design technical documents database includes information related to the technology process; and
an estimation module configured to analyze the information of the customer and evaluate for the impact to the customer by the revision of the technology process.

2. The customer impact estimation system of claim 1, wherein the predefined search scope includes a period of time, a type of technology, and a physical region.

3. The customer impact estimation system of claim 1, wherein the predefined search scheme includes document title, document number, vendor, maker, and end customer.

4. The customer impact estimation system of claim 3 wherein the vendor comprises one of an electronic design automation (EDA) vendor, a chip service company, a library and intellectual property (IP) vendor.

5. The customer impact estimation system of claim 3 wherein the maker comprises one of a photomask maker, a wafer manufacturer, a testing facility, and a packaging facility.

6. The customer impact estimation system of claim 1, wherein the design technical document database includes at least a process document, and at least a technical file.

7. The customer impact estimation system of claim 6, wherein the process document includes product specification document, design rule manual, and simulation model document.

8. The customer impact estimation system of claim 6, wherein the technical file includes a design-rule-check (DRC) document, a layout-versus-schematic (LVS) document, and a RC extraction document.

9. The customer impact estimation system of claim 1 wherein the system is further connected to a virtual fab that is a network entity.

10. The customer impact estimation system of claim 9 wherein the virtual fab is further connected to at least one of a customer, a vendor, a manufacturer, and a design group.

11. The customer impact estimation system of claim 9 wherein the virtual fab comprises a plurality of database including the design technical document database.

12. The customer impact estimation system of claim 1 wherein the user interface further provides a search result to a user.

13. The customer impact estimation system of claim 1 wherein the extraction module searches relevant documents according to the predefined search scheme.

14. The customer impact estimation system of claim 13 wherein the extraction module searches for customers who have downloaded the relevant documents during the predefined search scope.

15. The customer impact estimation system of claim 14 wherein the extraction module extracts information of the customers through download history relevant documents.

16. The customer impact estimation system of claim 1 wherein the estimation module provides a list of customers who are impacted by the revision of the technology process.

17. The customer impact estimation system of claim 16 wherein the estimation module further provides a list of customers who are impacted by the revision of the technology process according to a quantitative criteria.

18. The customer impact estimation system of claim 1 wherein the estimation module provides a quantitative estimation of customer impact by the revision of the technology process according to a quantitative criteria.

19. The customer impact estimation system of claim 18 wherein the estimation module further provides a suggestion for a communication with relevant customers, vendors, and makers for the revision of the technology process.

20. A method to evaluate an impact to a customer caused by a revision of a specific technology process in microelectronics manufacturing, the method comprising:
providing a search scope to a user interface;
providing a search scheme to the user interface; and
searching, according to the search scope and the search scheme, a design technical documents database that includes information related to the technology process to determine a customer impacted by the revision.

21. The method of claim 20 wherein the search scope includes one of a period of time, a type of technology, and a physical region of a customer.

22. The method of claim 21 wherein the search scheme includes one of a document title, a document number, a vendor, a maker and an end customer.

23. The method of claim 20 wherein the type of technology includes 0.25 μm and above, 0.25 μm to 0.15 μm, 0.15 μm to 0.09 μm, and below 0.09 μm.

24. The method of claim 20 wherein a period of time includes one of 3 months, 6 months, and 12 months.

25. The method of claim 20 wherein the vendor comprises one of an electronic design automation (EDA) vendor, a chip service company, a library and intellectual property (IP) vendor.

26. The method of claim 20 wherein the maker includes one of a photomask maker, a wafer manufacturer, a testing facility, and a packaging facility.

27. The method of claim 20 wherein the design database comprises one of design rule check (DRC) database, layout versus schematic (LVS) database, and RC extraction database.

28. The method of claim 20 wherein the searching is implemented by a customer impact estimation system connected to a virtual fab.

29. The method of claim 28 wherein the searching is implemented through the virtual fab, wherein the virtual fab is a network entity.

30. The method of claim 29 wherein the virtual fab is connected to at least a customer, a vendor, a manufacturer, and a design lab.

31. The method of claim 20 further comprising:
specifying a change of process wherein the change of process is associated with a technical document; and
verifying validity of the change of process according to a set of predefined rules.

32. A method to evaluate an impact to a customer caused by a revision of a specific technology process in microelectronics manufacturing, the method comprising:
specifying a change of process wherein the change of process is associated with a technical document;
verifying validity of the change of process according to a set of predefined rules;
providing a search scope;
providing a search scheme;
implementing a search of a plurality of design databases according to the search scope and the search scheme; and
providing a result of the search.
